(19) United States
(12) Patent Application Publication
(10) Pub. No.: US 2026/0081544 A1
(43) Pub. Date: Mar. 19, 2026

(54) CONSTANT INPUT POWER CONTROL METHOD FOR ELECTRIC MOTORS IN DOWNHOLE TOOLS

(71) Applicant: Halliburton Energy Services, Inc., Houston, TX (US)

(72) Inventors: Ariel Pinheiro Rangel Faria, Rio de Janeiro (BR); Ryan David Mair, Aberdeenshire (GB); Rodrigo de Carvalho Mendez, Rio de Janeiro (BR)

(73) Assignee: Halliburton Energy Services, Inc., Houston, TX (US)

(21) Appl. No.: 18/886,709

(22) Filed: Sep. 16, 2024

(51) Int. Cl. H02P 6/16; E21B 41/02; H02P 6/04

(52) U.S. Cl. CPC H02P 6/16; E21B 41/02; H02P 6/04

(57) ABSTRACT

Disclosed herein are various embodiments of a control system for use with an electric motor, the system comprising a measurement device in electrical connection with a power supply, to determine current (I_{PSU}) and voltage (V_{PSU}) provided by the power supply to the motor controller, a motor rotational feedback sensor positioned to determine rotational data of the motor, and a motor controller which accepts a power reference input (Power_{ref}), accepts I_{PSU} and V_{PSU} from the measurement device, multiplies them, and compares this result to Power_{ref}, utilizes this comparison to set a speed reference (ω_{ref}) that is desired at the motor, drives the motor at ω_{ref}, based on the rotational data, and continuously adjusts ω_{ref} to keep the product of I_{PSU} and V_{PSU} equal to Power_{ref}.

### BACKGROUND

Downhole tools are used to construct subterranean wells but these downhole tools have a number of design challenges and inefficiencies when used with electric motors that are also located downhole. Generally speaking, every electrical motor has an optimal operating point, being the most efficient in specific speed and load (torque) scenarios. However, these optimal scenarios happen often only on a small portion of the actual duty cycle of the motor, due to a number of limitations, including but not limited to fixed voltage supplies, mechanical drivetrain limitations, and/or varying load conditions in these types of applications. Thus, while an electric motor can be optimized for a set of specific speed and torque parameters, it can become very inefficient outside of these parameters. The use of small motors typically requires a gearbox in order to convert the high-speed low-torque output of a small motor to the required low-speed high-torque output requirement, but this can involve serious inefficacies and power loss. The use of large motors is thus desirable as the lack of a gearbox can remove these inefficiencies, but large motors typically cannot fit within a downhole tool. Therefore, for such applications, it is of great importance to implement strategies to manage the available power budget, making the motor control as efficient as possible.

### BRIEF DESCRIPTION OF THE DRAWINGS

These drawings illustrate certain aspects of some of the embodiments of the present disclosure and should not be used to limit or define the method.

FIG. 1 illustrates a schematic view of a well system that may employ the principles of the present disclosure within one or more downhole tools.

FIG. 2 illustrates a cross-sectional side view of one embodiment of a downhole tool having one or more motors along with an embodiment of the motor control system.

FIG. 3 illustrates the control logic used with one embodiment of the motor control system shown and described herein.

FIG. 4 illustrates an electrical component block diagram used with one embodiment of the motor control system shown and described herein.

FIG. 5 illustrates a graphical relationship between time and motor position (rotation counts) for one embodiment of the motor control system shown and described herein.

### DETAILED DESCRIPTION

The embodiments herein provide a control system and method intended to optimize the power management of one or more motors by embedding extra logic into a closed-loop PID speed control, effectively creating a power-based control loop. Additionally, this extra logic also provides the ability to operate multiple motors in a synchronized manner. Embodiments of said system and logic are intended to be part of the firmware implementation of a motor controller. A motor controller with this firmware may form part of the electronics of a downhole tool, where it will control the motors and perform its features of power management and synchronization by constantly setting the speed reference for each motor's operation adequately. The decision on whether to increase, decrease, or keep the speed reference of each motor constant is performed by a heuristic-based decision tree in the logic, where all the relevant input measurements are evaluated, and the corresponding outputs are generated, according to the operating speed/torque conditions.

The embodiments herein also provide a motor control system and method which constantly compares control variables (ex: ω [RPM], power [W]) to target references, adjusting them to make the errors tend to 0. The calculations performed may be reduced to simple additions and multiplications. In general terms, some embodiments provide a “higher level control loop”—including power control and synchronization features—which can be used to set the reference speeds for one or more “inner loops”. In some embodiments the inner loops may be similar to some of the standard implementations of motor speed control (ex. PI Speed Controller). Stated another way, the higher loop can be used to control a plurality of motors as a group while simultaneously setting and transmitting the references to the inner loops which work within each individual motor's control feedback.

The voltage and current measurements for the power management feature may be taken directly at the power supply level, which simplifies the control and increases the accuracy because the measurements are taken at the input of the system, therefore accounting for all the inefficiencies present on it (which are dynamic and dependent on speed/torque conditions as well as temperatures, pressures, and other factors). The measurements for the multiple motors' synchronization may consist of a combination of two distinct types of feedbacks: motor shaft rotational position, which can be obtained by direct feedback using sensors or by rotations counting; and current measurements (power consumption), taken directly at the motor (or controller or power supply); the motor rotational position can be used to ensured that both motors have performed equivalent amount of rotations, and the power consumptions can be used to ensure that both motors are consuming equivalent power. Finally, a position sensor reading can also be used to indicate the position of an actuator or moving body, feeding this information back to the control.

Embodiments herein provide a control system for use with an electric motor, the system comprising a measurement device in electrical connection with a power supply, to determine current (I_{PSU}) and voltage (V_{PSU}) provided by the power supply to the motor controller, a motor rotational feedback sensor positioned to determine rotational data of the motor, and a motor controller which accepts a power reference input (Power_{ref}), accepts I_{PSU} and V_{PSU} from the measurement device, multiplies them, and compares this result to Power_{ref}, utilizes this comparison to set a speed reference (ω_{ref}) that is desired at the motor, drives the motor at ω_{ref}, based on the rotational data, and continuously adjusts ω_{ref} to keep the product of I_{PSU} and V_{PSU} equal to Power_{ref}.

Further embodiments comprise a motor current sensor positioned to measure the current draw of the motor (Iₘₒₜₒᵣ) and transmit Iₘₒₜₒᵣ to the motor controller. Further embodiments comprise a body position sensor positioned to measure the linear position of a mechanical body and transmit this data to the motor controller, and wherein the motor controller further adjusts ω_{ref} until a desired linear position is reached. Further embodiments wherein the motor controller further adjusts ω_{ref} until the product of I_{PSU} and V_{PSU} is equal to Power_{ref}. Further embodiments wherein the motor rotational feedback sensor is positioned to measure the total number of rotations of the motor and transmit this data to the motor controller.

Embodiments herein provide a control system for use with a plurality of electric motors, the system comprising a first measurement device in electrical connection with a power supply to determine current (I_{PSUmotor1}) and voltage (V_{PSUmotor1}) provided by the power supply to the first motor driver, which controls a first motor, a first motor rotational feedback sensor (or equivalent method), to measure the rotational data of the first motor, a second measurement device in electrical connection with a power supply to determine current (I_{PSUmotor2}) and voltage (V_{PSUmotor2}) provided by the power supply to a second motor driver, which controls a second motor, a second motor rotational feedback sensor (or equivalent method), to measure the rotational data of the second motor, and a motor controller which accepts a power reference input (Power_{ref}), accepts I_{PSUmotor1}, V_{PSUmotor1}, I_{PSUmotor2}, and V_{PSUmotor2} from the measurement devices, performs (I_{PSUmotor1}×V_{PSUmotor1})+(I_{PSUmotor2}×V_{PSUmotor2}) and compares this result to the desired Power_{ref}, utilizes this comparison to set a first speed reference (ω_{ref1}) that is desired at the first motor and a second speed reference (ω_{ref2}) that is desired at the second motor, drives the first motor at ω_{ref1} and the second motor at ω_{ref2} based on the rotational data for each motor, continuously adjusts ω_{ref1} and ω_{ref2}, as necessary to keep the result of (I_{PSUmotor1}×V_{PSUmotor1})+(I_{PSUmotor2}×V_{PSUmotor2}) equal to Power_{ref}.

Further embodiments wherein the first motor rotational feedback sensor is used to measure the rotations count (N₁) of the first motor, the second motor rotational feedback sensor is used to measure the rotations count (N₂) of the second motor, and the motor controller further adjusts ω_{ref1} and ω_{ref2} until N₁ is equal to N₂ (position synchronization). Further embodiments wherein the first motor individual power consumption P₁=(I_{PSUmotor1}×V_{PSUmotor1}) is determined with the information from the first measurement system, the second motor individual power consumption P₂=(I_{PSUmotor2}×V_{PSUmotor2}) is determined with the information from the second measurement system, and the motor controller further adjusts ω_{ref1} and ω_{ref2} until P₁ is equal to P₂ (power consumption synchronization). Further embodiments wherein the motor controller accepts a first gain K_{c} to determine how much influence position synchronization has over the control system, and a second gain Kₚ to determine how much influence power consumption synchronization has over the control system. Further embodiments wherein the motor controller sets ω_{ref1} and ω_{ref2} individually, as determined by by the first gain K_{c} and second gain Kₚ.

Further embodiments wherein a third measurement device in electrical connection with a power supply to determine current (I_{PSUmotor3}) and voltage (V_{PSUmotor3}) provided by the power supply to a third motor controller, which commands a third motor, a third motor rotational feedback sensor, to measure the rotational data of the third motor, and wherein the motor controller further: accepts I_{PSUmotor1}, V_{PSUmotor1}, I_{PSUmotor2}, V_{PSUmotor2} I_{PSUmotor1}, V_{PSUmotor1}, I_{PSUmotor3}, and V_{PSUmotor3} from the measurement devices, performs (I_{PSUmotor1}×V_{PSUmotor1})+(I_{PSUmotor2}×V_{PSUmotor2})+(I_{PSUmotor3}×V_{PSUmotor3}) and compares this result (R) to the desired Power_{ref}, utilizes this comparison to set a first speed reference (ω_{ref1}) that is desired at the first motor, a second speed reference (ω_{ref2}) that is desired at the second motor, and a third speed reference (ω_{ref3}) that is desired at the third motor, drives the first motor at ω_{ref1}, the second motor at ω_{ref2}, and the third motor at ω_{ref3} based on the rotational data for each motor, continuously adjusts ω_{ref1}, ω_{ref2}, and ω_{ref3} to keep R equal to Power_{ref}.

Embodiments herein provide a method for controlling electric motors comprising accepting a power reference input (Power_{ref}), accepting I_{PSU} and V_{PSU} from a measurement device, multiplying them, and comparing this result to Power_{ref}, selecting a speed reference (ω_{ref}) that is desired at the motor based on this comparison, driving the motor at ω_{ref}, based on rotational data, and continuously adjusting ω_{ref} to keep the product of I_{PSU} and V_{PSU} equal to Power_{ref}. Further embodiments comprising measuring the linear position of a mechanical body, and adjusting ω_{ref} until a desired linear position is reached. Further embodiments comprising measuring the total number of rotations of the motor. Further embodiments comprising accepting I_{PSUmotor2} and V_{PSUmotor2} from a measurement device,

performing (I_{PSUmotor1}×V_{PSUmotor1})+(I_{PSUmotor2}×V_{PSUmotor2}) and comparing this result to Power_{ref}, setting a first speed reference (ω_{ref1}) that is desired at a first motor and a second speed reference (ω_{ref2}) that is desired at a second motor based on the comparison, driving the first motor at ω_{ref1} and the second motor at ω_{ref2} based on rotational data for each motor, continuously adjusting ω_{ref1} and ω_{ref2}, as necessary to keep the result of (I_{PSUmotor1}×V_{PSUmotor1})+(I_{PSUmotor2}×V_{PSUmotor2}) equal to Power_{ref}. Further embodiments comprising measuring the rotations count (N₁) of the first motor, measuring the rotations count (N₂) of the second motor, and further adjusting ω_{ref1} and ω_{ref2} until N₁ is equal to N₂.

Further embodiments comprising determining P₁=(I_{PSUmotor1}×V_{PSUmotor1}), determining P₂=(I_{PSUmotor2}×V_{PSUmotor2}), and further adjusting ω_{ref1} and ω_{ref2} until P₁ is equal to P₂. Further embodiments comprising accepting a first gain to determine how much influence N₁ is equal to N₂ has over the adjusting for ω_{ref1} and ω_{ref2}, and a second gain to determine how much influence P₁ is equal to P₂ has over the adjusting for ω_{ref1} and ω_{ref2}.

At least one embodiment of the control system and method consists of a variation of a closed-loop PID control, containing an extra logic block that adds at least two distinct features: power-based motor control and the ability to perform synchronized multi-motor control.
100 platform
105 sea level
110 production riser
115 blow out preventer (BOP)
120 tubing hanger
125 well system
130 well casing
135 electrical conductor
140 hydraulic control/injection lines
145 formation
150 open hole section (ie. no casing)
155 data acquisition and control unit
160 electrical umbilical
165 seabed
170 upper completion
175 lower completion
180 downhole tool
185 work string
200 tool body
205 actuator electronics
210 motor control electronics (eg. motor controller(s))
215 electrical conductors to other motors and their rotational feedback sensors
220 electrical conductors to motor and body position sensor 280
225 motor rotational feedback sensor (eg. hall sensors, resolver, encoder or similar)
230 motor
235 gearbox
240 output shaft
245 screw
250 coupling
255 sleeve
260 flow ports
265 bore
270 additional motor assembly
280 body position sensor
300 control logic
301 input variable ωₘₐₓ
302 input variable Pₘₐₓ
303 measurement variables P₁/P₂
304 measurement variables C₁/C₂
305 control variable ΔP
306 control variable ΔC
307 input variables Kₚ/K_{c}
308 input variable K_{PM}
309 control variable ω_{ref}
310 control variables ω_{ref1}/ωr_{ef2}
350 additional control logic for additional motor assembly 270
400 additional controls for additional motor assembly 270
410 power supply
411 power supply measurement device
413 speed controller
414 current limiter
415 current controller
416 converter
417 motor current sensor
418 motor driver

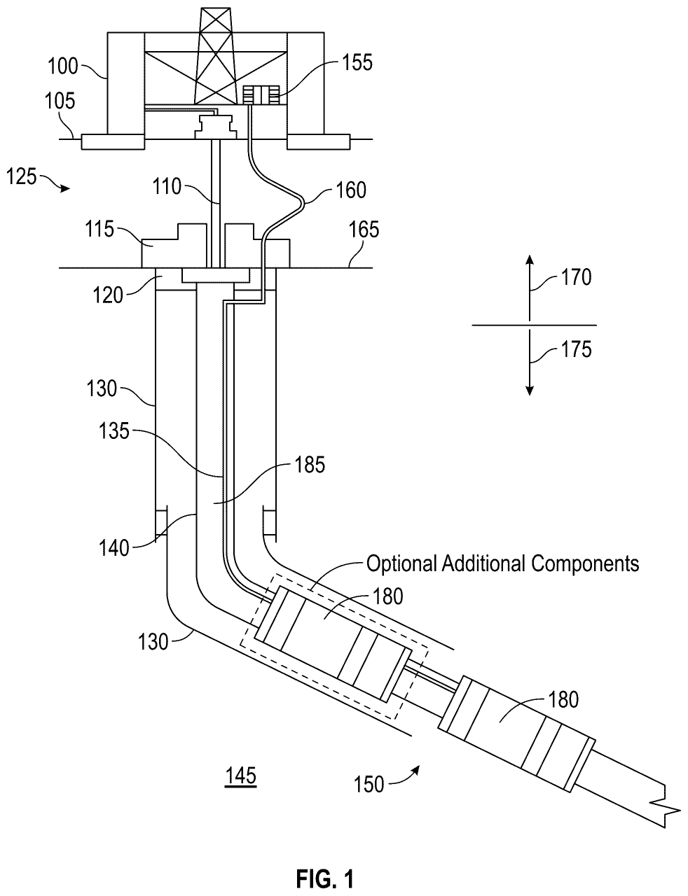

FIG. 1 illustrates a schematic view of a well system 125 that may employ the principles of the present disclosure within one or more downhole tools.

A platform 100 may be positioned on the surface of the sea and held at sea level 105. Alternatively, the embodiments herein can also be practiced with land-based drilling and well production, where the sea level 105 would instead be ground level. An electrical umbilical 160 may be used to electrically connect a data acquisition and control unit 155 to an electrical conductor 135 that is run down hole. A blow out preventer (BOP) 115 may be positioned on the sea bed 165 with a production riser 110 connected to the BOP 115. A tubing hanger 120 may be positioned at the sea bed 165 to support the well casing 130. An electrical conductor 135 may then run down the work string 185 and will connect to the internal components of the downhole tool 180 as will be described further below.

Generally speaking, all of the components near the tubing hanger 120 and above can be referred to as the upper completion 170 while the components below this area would be referred to as the lower completion 175. A series of well casings 130 may be connected and run through the wellbore until the deepest part of the wellbore which lacks any casing which is also referred to as the open hole section 150 of the well, typically in a desirable area of a geological formation 145. The embodiments herein provide for downhole tools 180 which can be used in any section of a well including both the sections that include well casings 130 or sections which are open 150.

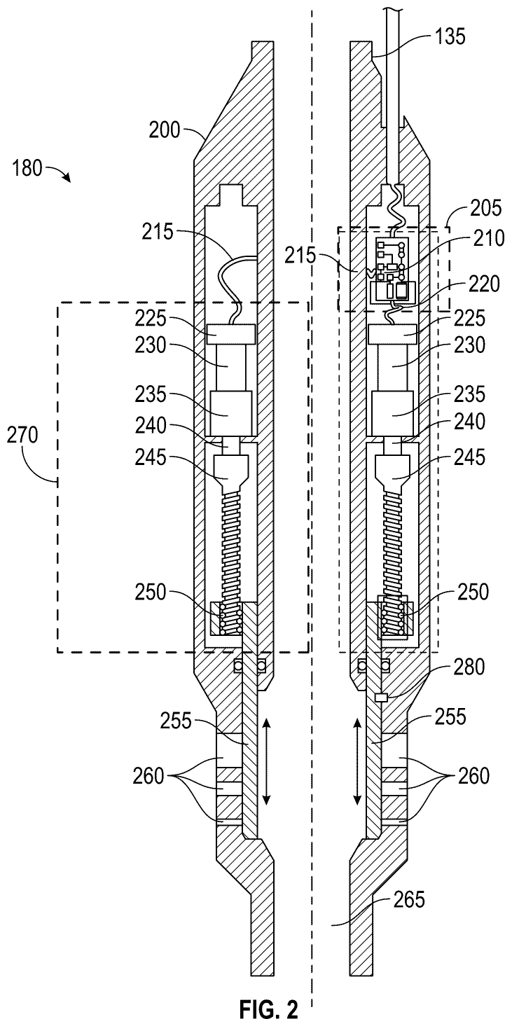

FIG. 2 illustrates a cross-sectional side view of one embodiment of a downhole tool 180 having one or more motors along with an embodiment of the motor control system. The electrical conductor 135 may traverse through the work string 185 until entering the tool body 200 and connecting with the actuator electronics 205 which may contain a motor controller 210. An electrical conductor (or multiple conductors) 220 may exit the actuator electronics 205 to connect with a motor 230 and various sensors within the downhole tool 180 including but not limited to a motor rotational feedback sensor 225. The output shaft of the motor 230 may then be connected to a gear box 235 which has an output shaft 240 that connects to some type of mechanical body, in this embodiment a screw 245 may be threaded into a coupling 250. In alternative embodiments, the mechanical body could be a valve.

Here, a sleeve 255 may be connected to the coupling 250 such that rotation of the screw 245 causes a linear translation of the sleeve 255 to reveal one or more flow ports 260. The downhole tool 180 also preferably includes a bore 265 that runs down the central axis of the downhole tool 180. In some embodiments, a body position sensor 280 may be positioned near the mechanical body that is connected to the gear box 235 to determine the position of the mechanical body. In this embodiment, the body position sensor 280 may be positioned to determine the linear position of the sleeve 255 as it extends and retracts to cover the plurality of flow ports 260. This sensor 280 can provide feedback to the control system of the present location of the sleeve 255 (or other mechanical body), allowing it to confirm movement when the sleeve is being moved and to stop the movement at the intended location.

Similarly, embodiments of the downhole tool 180 can contain one or more additional motor assemblies 270 including the following components: motor rotational feedback sensor 225, motor 230, gearbox 235, screw 245, and coupling 250. In some embodiments, each additional motor assembly 270 may be connected to its own sleeve 255 or in other embodiments each motor assembly may also connect to the same sleeve 255.

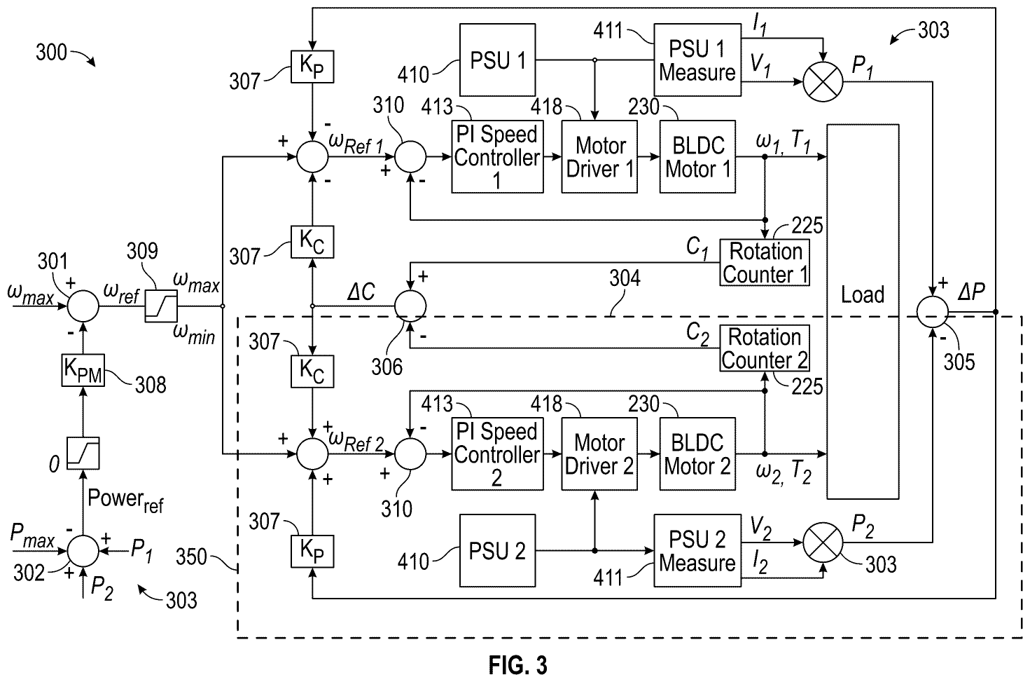

FIG. 3 illustrates the control logic 300 used with one embodiment of the motor controller 210 shown and described herein. The input variable ωₘₐₓ 301 may be used to represent the maximum speed allowed for any motor in the system and can be referred to as an input to the motor control logic 300 and could be reprogrammable or configurable. The input variable Pₘₐₓ 302 could be referred to as the maximum power allowed for the entire system, will be divided among the various motors (if necessary) and can be referred to as an input to the motor control logic 300 and could be reprogrammable or configurable.

The measurement variables P₁/P₂ 303 may be referred to as individual power measurements for each motor on the system, obtained by the product of measured Voltage (V) and Current (I) for each motor's supply. The variables P₁/P₂ 303 may be compared to the variable Pₘₐₓ 302 to distribute the power amongst various motors without exceeding a maximum power set for the system, which could be elected as the point where the efficiency of the system begins to decline and/or according to power availability constraints for the downhole tool 180, in some specific well system 125 conditions. After comparing to determine how much power is required from each motor, a desired power for each motor Power_{ref} is determined.

Even though two blocks of Power Supply Units (PSU) are represented, there is nothing preventing a single PSU to be used, as long as there are separate measurement blocks for each motor driver 418. The Voltage and Current measurements depicted represent the inputs of the motor driver 418, meaning that its product represents the individual power consumption of each motor driver 418. In terms of how to perform the measurements, several techniques can be used. Voltage can be measured directly through an Analog to Digital Converter (ADC), with possible adjustments in terms of gain by amplifier stages. Currents can be measured directly—using a shunt resistor and measuring the drop across it—or indirectly—using a Hall Effect sensor. Regardless of method, the output signal is typically a voltage, which can also be measured through an ADC, and adjusted in terms of gain with amplifier stages.

The measurement variables C₁/C₂ 304 may represent individual rotation count(s) measurements for each motor on the system. Can be obtained by several methods, for example, using direct measurement on the motor shaft (encoder, hall-effect sensors, resolver) or indirectly, by commutation counts.

BLDC Motors have internal poles, which operate in pairs and need to be electrically activated at the correct times to keep the motor running. There are a minimum of 6 poles, equally spaced by 60° along the shaft. In this configuration, a BLDC motor performs 1 mechanical revolution on every electrical revolution (6 commutations, or pole activations, at 60° apart). There can also be more pole pairs in the system, which requires the distance (in degrees) between them to be reduced, meaning more electrical revolutions (commutations) are necessary to account for a mechanical revolution. Regardless, accurate rotational count is possible in any case, since the motor is being commanded to perform the commutations, and the relationship between the amount of pole pairs and a mechanical revolution (360°) is a known characteristic for any BLDC motor.

When using multiple motors, the control variable ΔP 305 can be derived from P₁/P₂, which represents the difference in power consumption between the multiple motors. The control variable ΔP 305 can be positive (if motor 1 is consuming more power) or negative (if motor 2 is consuming more power).

The control variable ΔC 306 may be derived from C1/C2 and may represent the difference in rotation counts between the motors. This value can be positive (if motor 1 has rotated more) or negative (if motor 2 has rotated more). This logic can be reduced to a single motor or extended to more than two motors as described below.

To use the control logic 300 with only a single motor, ΔP and ΔC would be always equal zero, and the loop essentially becomes a constant power control for a single motor, in which ω_{ref} is only influenced by the power consumption P₁, compared to the maximum reference Pₘₐₓ.

To extend the control logic 300 to more than two motors, the control loop would have to be adjusted to create and compare multiple ΔP's and ΔC's. For example, if 3 motors are used, there would be ΔP₁₂/ΔC₁₂, ΔP₁₃/ΔC₁₃ and ΔP₂₃/ΔC₂₃, representing the deltas between each motor and the other 2. Then, the ΔP's and ΔC's would be used accordingly to adjust each motor speed i.e., motor 1 speed (ω_{ref1}) would be influenced by ΔP₁₂/ΔC₁₂ and ΔP₁₃/ΔC₁₃, motor 2 speed (ω_{ref2}), by ΔP₁₂/ΔC₁₂ and ΔP₂₃/ΔC₂₃, and motor 3 speed (ω_{ref3}), by ΔP₁₃/ΔC₁₃ and ΔP₂₃/ΔC₂₃.

The input variables Kₚ/K_{c} 307 may represent gains for the synchronization control (Kₚ for Power and K_{c} for Rotation Counts or Position). These gains may be considered inputs to the motor control logic and could be reprogrammable or configurable. The input variables Kₚ/K_{c} 307 may determine the intensity of the system response to the differences (errors) ΔP and ΔC. The synchronization control gains can be adjusted to different weights, determining which variable affects the system with more intensity. The gains can also be set to zero, effectively deactivating that particular control. The position synchronization control feature is independent from the power consumption synchronization control which is why they can be balanced with different gains. The response may be obtained through PID control.

For position synchronization control the first motor rotational feedback sensor 225 may be used to measure the rotations count (N₁) of the first motor, while the second motor rotational feedback sensor 225 is used to measure the rotations count (N₂) of the second motor. During this process, the motor controller further adjusts ω_{ref1} and ω_{ref2} until N₁ is equal to N₂.

For power consumption synchronization control the first motor individual power consumption P₁=(I_{PSUmotor1}×V_{PSUmotor1}) is determined with the information from the first measurement system while the second motor individual power consumption P₂=(I_{PSUmotor2}×V_{PSUmotor2}) is determined with the information from the second measurement system. During this process, the motor controller further adjusts ω_{ref1} and ω_{ref2} until P₁ is equal to P₂.

In one embodiment, the control system's measurements and response calculations are represented as high-level data acquisition, sum, multiplication and limiter blocks. They may be agnostic to the signals measurement method and PID implementations chosen (works with analog or digital PID controls, with individual P, I, D or any combination of them, both in series or parallel configurations) and at any sampling rate and control variable rate limits. These parameters are to be determined by the designer based on the application in which the control scheme is being applied to.

The input variable K_{PM} 308 may represent Gain for the overall constant power control (K_{PM}). This gain may be used as an input to the motor control logic 300 (and could be reprogrammable or configurable). The input variable K_{PM} 308 may determine the intensity of the system response to a difference (error) between the reference maximum power Pₘₐₓ and the sum of the individual Power Measurements for the motors. The Power Control feature may be independent from the Synchronization Control. The response may be obtained through PID control.

The control variable ω_{ref} 309 may be derived from the maximum speed allowed for the motors in the system (ωₘₐₓ), limited by the power consumption of the motors combined. If P₁+P₂≤Pₘₐₓ, then the power consumption has no limiting effect on ω_{ref} and the motors are allowed to achieve up to the maximum speed (the limiter at 0 ensures no negative numbers are subtracted from ωₘₐₓ). If P₁+P₂>Pₘₐₓ, then ω_{ref} is progressively decreased, limiting the speed the motors are allowed to achieve and ensuring the power consumption of the system does not increase beyond the programmed maximum (Pₘₐₓ). The intensity of the effect is controlled by the gain K_{PM}. There is also a limiter programmed to constrain the range of ω_{ref} to ωₘᵢₙ and ωₘₐₓ, the minimum and maximum allowable speeds in the system.

The control variables ω_{ref1}/ω_{ref2} 310 may represent the Synchronization Control Feature, derived from the reference speed for the motors in the system after the Power Control (ω_{ref}), and the differences (errors) between power consumption (ΔP) and rotation counts (ΔC) between the motors. If ΔP>0 (motor 1 consuming more power), then motor 1 is slowed down (ω_{ref1} is decreased), while motor 2 is sped up (ω_{ref2} is increased), aiming to equate the power consumption of the motors. The intensity of the effect is controlled by the gain Kₚ. If ΔP<0 (motor 1 consuming less power), the opposite is achieved, with motor 1 being sped up and motor 2 being slowed down. Similarly, if ΔC>0 (motor 1 performed more rotations), then motor 1 is slowed down (ω_{ref1} is decreased) while motor 2 is sped up (ω_{ref2} is increased), aiming to equate the number of rotations performed by the motors. The intensity of the effect is controlled by the gain K_{c}. If ΔC<0 (motor 1 performed less rotations), the opposite is achieved, with motor 1 being sped up and motor 2 being slowed down.

The control logic 300 (generally referred to as constant power with synchronized motors) is agnostic to the implementation method. It was represented closer to a digital control system, but it could also be implemented as an analog control system. The inner motor control loop (PI Speed Controller 413, which determines how the motor driver electrically controls the BLDC motor to meet its target speed) can also be implemented in multiple ways—for example, using trapezoidal commutation or sinusoidal control, with the use of feedback sensors or without (ie. sensor less). Additionally, even though some portions of the disclosure present a BLDC motor as its main object, different types of motors could be used (e.g., stepper motor, linear motor, etc.), requiring only minor adjustments to accommodate each motor specific characteristics.

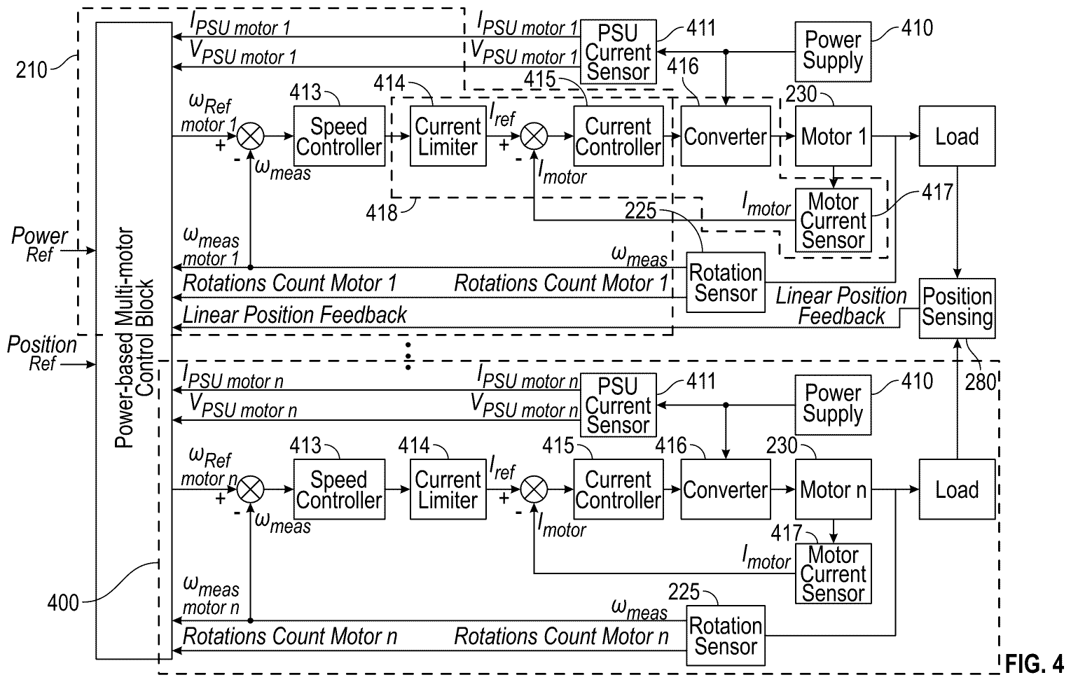

FIG. 4 illustrates an electrical component block diagram used with one embodiment of the motor controller 210 shown and described herein. In some embodiments, the components shown within the dashed line for the motor controller 210 may be considered the firmware implementation which may be software installed within one or more components using CPUs, processors or any type of processing unit. The components outside of the dashed box may be described as electrical hardware (e.g. resistors, capacitors, inductors, transistors, transformers, memory—RAM, ROM—or similar, interconnected through wires and/or mounted to printed circuit boards—PCB's, hybrid circuits or application-specific integrated circuits-ASIC's), while the motor(s) and the load may be considered mechanical components.

The motor controller 210 may contain electronic storage and electronic processing components to accept and process the various types of data being transmitted to/from the controller 210.

The motor controller 210 may receive data from a power supply measurement device 411 which is placed in electrical connection with the power supply 410 to determine the current (I_{PSUmotor1}) and the voltage (V_{PSUmotor1}) being produced by the power supply 410 and transmitted to a converter 416. The motor controller 210 may also receive data from a motor rotational feedback sensor 225 positioned to measure a) the total rotations count of motor 230 as well as b) the measured speed of the motor 230 (ωₘₑₐₛ) typically measured in RPMs.

The motor controller 210 may accept a power reference input (Power_{ref}) and then drive the motor(s) based on the goal of achieving this power reference while monitoring the current (I_{PSUmotor1}), voltage (V_{PSUmotor1}), Rotations count, and the measured speed (ωₘₑₐₛ) of each motor.

In some embodiments, an optional motor current sensor 417 is positioned to measure the current drawn by the motor 230 (Iₘₒₜₒᵣ) and transmit this data in a feedback loop to be compared with the reference current (I_{ref}) prior to being produced at the current controller 415.

The motor controller 210 may produce a desired speed reference (ω_{Refmotor1}) or a set of speed references through additional control 400 (ω_{RefmotorN}) based on the power reference input (Power_{ref}), and this could be done through a look up table, basic mathematic operation, or other correlating formulas that compare the speed and power consumption of the motor(s) to the system speed and power targets, such as depicted in the control loop from FIG. 3. The desired speed reference(s) (ω_{Refmotor}) may be compared to the measured speed of the motor(s) (ωₘₑₐₛ) to correct for any errors or noise in the system and ensure that the desired motor speed is the actual speed produced at the motor (in other words, making adjustments to the to the power sent to the motor to make ωₘₑₐₛ approximately equal to ω_{Refmotor} at all times). The desired speed can then be sent to a speed controller 413 which may determine the current necessary to produce the desired speed at the motor, again either through a look-up table, a basic mathematic operation, or a correlating formula. The data representing the necessary current may then be sent to a current limiter 414 which may be programmed to ensure that the necessary or desired current never exceeds a maximum current allowed at the motor (to prevent damage to the motor or for maximizing efficiency). The resulting desired current (I_{ref}) may then be produced by a current controller 415 which communicates electronically with a motor driver/converter 416 to obtain the desired current (I_{ref}) from the power supply 410. A resulting current may then be sent to the motor 230 where in some embodiments a motor current sensor 417 may be positioned to measure the actual current at the motor (Iₘₒₜₒᵣ) and transmit this data in a feedback loop to be compared with the desired current (I_{ref}) with adjustments made until the difference between Iₘₒₜₒᵣ and I_{ref} is as small as possible or near zero.

In some embodiments, the motor controller 210 may also accept data from body position sensor 280 which is positioned to measure the linear position of the mechanical body providing the load and send this data (Linear Position feedback) to the motor controller 210. In these cases, the motor controller 210 may accept a reference position (Position_{ref}) and may compare this with the data coming from the body position sensor 280 to determine when the system has reached the desired reference position (Position_{ref}) and make any necessary adjustments if necessary to ensure the desired position is achieved.

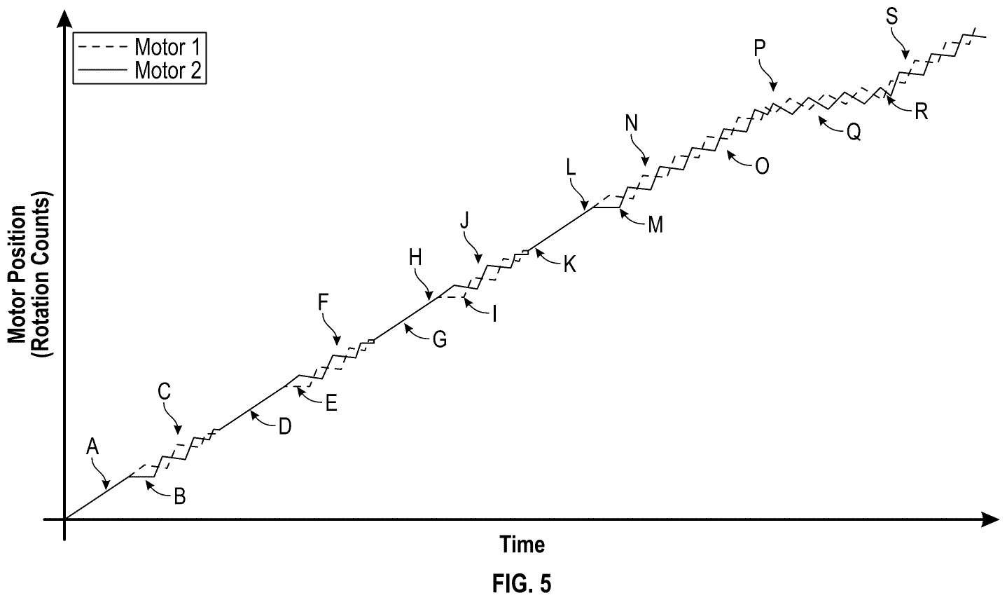

FIG. 5 illustrates a graphical relationship between time and motor position (rotation counts) for one embodiment of the motor control system shown and described herein. A series of various points in time (Time A through Time S) are shown with the performance of motor 1 compared with motor 2.

At Time A, motors are synchronized (Δc=0, ΔP=0) and running at ωmax because total power is below maximum (P1+P2<Pmax, ωref=ωmax) . At Time B, motor 1 rotations count is getting ahead of Motor 2, with balanced load (Δc>0, ΔP=0). At Time C, motor 1 and 2 reference speeds get adjusted, as necessary to achieve synchronization. At Time D, motors are synchronized again (Δc=0, ΔP=0) and running at ωmax because total power is below maximum (P1+P2<Pmax, ωref=ωmax). At Time E, motor 2 rotations count is getting ahead of motor 1, with balanced load (Δc<0, ΔP=0). At Time F, motor 1 and motor 2 reference speeds get adjusted, as necessary to achieve synchronization. At Time G, motors are synchronized again (Δc=0, ΔP=0) and running at ωmax because total power is below maximum (P1+P2<Pmax, ωref=ωmax). At Time H, motor 1 faces temporary higher load and its power consumption is increased, without exceeding maximum power (Δc=0, ΔP>0, P1+P2<Pmax).

At Time I, control loop 413 reacts by decreasing the speed of motor 1, to decrease its power consumption. However, this also creates a mismatch in rotations count (Δc<0, ΔP=0). At Time J, motor 1 and motor 2 reference speeds get adjusted, as necessary to achieve synchronization. At Time K, motor 1 temporary higher load is gone, and both motors are running together again. At Time L, for some reason, motor 2 faces permanent higher load and its power consumption is increased, without exceeding maximum power (Δc=0, ΔP<0, P1+P2<Pmax). At Time M, control loop 413 reacts by decreasing speed of motor 2, to decrease its power consumption. However, this also creates a mismatch in rotations count (Δc>0, ΔP=0). At Time N, motor 1 and motor 2 reference speeds get adjusted, as necessary to achieve synchronization. However, since motor 2 is permanently consuming more power (ΔP<0), synchronization is achieved through stable oscillatory behavior.

At Time O, external load is applied to both motors, increasing their power consumptions equally, making total power consumption exceed maximum (P1+P2>Pmax). At Time P, overall speed of motors is reduced (ωref<ωmax), to ensure that maximum power is not being exceeded (P1+P2=Pmax). At Time Q, oscillatory behavior continues because motor 2 is still facing permanent higher load than motor 1. However, positions are still synchronized, and not diverging. At Time R, external load is removed from both motors, decreasing their power consumptions equally, making total power consumption fall below maximum (P1+P2<Pmax). At Time S, the overall speed of motors is increased up to maximum (ωref=ωmax), since power is not being exceeded anymore (P1+P2<Pmax).

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A control system for use with a motor, the control system comprising:
a measurement device in electrical connection with a power supply, to determine current (I_{PSU}) and voltage (V_{PSU}) provided by the power supply to a motor controller;
a motor rotational feedback sensor positioned to determine rotational data of the motor; and
a motor controller which
accepts a power reference input (Power_{ref});
accepts I_{PSU} and V_{PSU} from the measurement device, multiplies them, and compares this result to Power_{ref};
utilizes this comparison to set a speed reference (ω_{ref}) that is desired at the motor;
drives the motor at ω_{ref}; based on the rotational data; and
continuously adjusts ω_{ref} to keep a product of I_{PSU} and V_{PSU} equal to Power_{ref}.

2. The control system of claim 1 further comprising:
a motor current sensor positioned to measure current draw of the motor (Iₘₒₜₒᵣ) and transmit Iₘₒₜₒᵣ to the motor controller.

3. The control system of claim 1 further comprising:
a body position sensor positioned to measure linear position of a mechanical body and transmit this data to the motor controller; and
wherein the motor controller further adjusts ω_{ref} until a desired linear position is reached.

4. The control system of claim 1 wherein:
the motor controller further adjusts ω_{ref} until the product of I_{PSU} and V_{PSU} is equal to Power_{ref}.

5. The control system of claim 1 wherein:
the motor rotational feedback sensor is positioned to measure total number of rotations of the motor and transmit this data to the motor controller.

6. A control system for use with a plurality of electric motors, the control system comprising:
a first measurement device in electrical connection with a power supply to determine current (I_{PSUmotor1}) and voltage (V_{PSUmotor1}) provided by the power supply to a first motor driver, which controls a first motor;
a first motor rotational feedback sensor (or equivalent method), to measure rotational data of the first motor;
a second measurement device in electrical connection with a power supply to determine current (I_{PSUmotor2}) and voltage (V_{PSUmotor2}) provided by the power supply to a second motor driver, which controls a second motor;
a second motor rotational feedback sensor, to measure rotational data of the second motor; and
a motor controller which
accepts a power reference input (Power_{ref})
accepts I_{PSUmotor1}, V_{PSUmotor1}, I_{PSUmotor2}, and V_{PSUmotor2} from the first measurement device and the second measurement device, performs (I_{PSUmotor1}×V_{PSUmotor1})+(I_{PSUmotor2}×V_{PSUmotor2}) and compares this result to a desired Power_{ref};
utilizes this comparison to set a first speed reference (ω_{ref1}) that is desired at the first motor and a second speed reference (ω_{ref2}) that is desired at the second motor;
drives the first motor at ω_{ref1} and the second motor at ω_{ref2} based on rotational data for each motor; and
continuously adjusts ω_{ref1} and ω_{ref2}, as necessary to keep the result of (I_{PSUmotor1}×V_{PSUmotor1})+(I_{PSUmotor2}×V_{PSUmotor2}) equal to Power_{ref}.

7. The control system of claim 6 wherein:
the first motor rotational feedback sensor is used to measure the rotations count (N₁) of the first motor;
the second motor rotational feedback sensor is used to measure the rotations count (N₂) of the second motor; and
the motor controller further adjusts ω_{ref1} and ω_{ref2} until N₁ is equal to N₂ (position synchronization).

8. The control system of claim 7 wherein:
a first motor individual power consumption P₁=(I_{PSUmotor1}×V_{PSUmotor1}) is determined with information from the first measurement device;
a second motor individual power consumption P₂=(I_{PSUmotor2}×V_{PSUmotor2}) is determined with information from the second measurement device; and
the motor controller further adjusts ω_{ref1} and ω_{ref2} until P₁ is equal to P₂ (power consumption synchronization).

9. The control system of claim 8 wherein:
the motor controller accepts
a first gain K_{c} to determine how much influence position synchronization has over the control system; and
a second gain Kₚ to determine how much influence power consumption synchronization has over the control system.

10. The control system of claim 9 wherein:
the motor controller sets ω_{ref1} and ω_{ref2} individually, as determined by by the first gain K_{c} and second gain Kₚ.

11. The control system of claim 6 further comprising:
a third measurement device in electrical connection with the power supply to determine current (I_{PSUmotor3}) and voltage (V_{PSUmotor3}) provided by the power supply to a third motor controller, which commands a third motor;
a third motor rotational feedback sensor, to measure the rotational data of the third motor; and
wherein the motor controller further:
accepts I_{PSUmotor1}, V_{PSUmotor1}, I_{PSUmotor2}, V_{PSUmotor2} I_{PSUmotor1}, V_{PSUmotor1}, I_{PSUmotor3}, and V_{PSUmotor3} from the first measurement device and the second measurement device;
performs (I_{PSUmotor1}×V_{PSUmotor1})+(I_{PSUmotor2}×V_{PSUmotor2})+(I_{PSUmotor3}×V_{PSUmotor3}) and compares this result (R) to the desired Power_{ref};
utilizes this comparison to set a first speed reference (ω_{ref1}) that is desired at the first motor, a second speed reference (ω_{ref2}) that is desired at the second motor, and a third speed reference (ω_{ref3}) that is desired at the third motor;
drives the first motor at ω_{ref1}, the second motor at ω_{ref2}, and the third motor at ω_{ref3} based on the rotational data for each motor; and
continuously adjusts ω_{ref1}, ω_{ref2}, and ω_{ref3} to keep R equal to Power_{ref}.

12. A method for controlling downhole electric motors comprising:
accepting a power reference input (Power_{ref});
accepting I_{PSU} and V_{PSU} from a measurement device, multiplying them, and comparing this result to Power_{ref};
selecting a speed reference (ω_{ref}) that is desired at a first downhole motor based on this comparison;
driving the first downhole motor at ω_{ref}; based on rotational data; and
continuously adjusting ω_{ref} to keep a product of I_{PSU} and V_{PSU} equal to Power_{ref}.

13. The method of claim 12 further comprising:
measuring linear position of a downhole mechanical body; and
adjusting ω_{ref} until a desired linear position is reached.

14. The method of claim 12 further comprising:
measuring total number of rotations of the first downhole motor.

15. The method of claim 12 further comprising:
accepting I_{PSUmotor2} and V_{PSUmotor2} from a second measurement device;
performing (I_{PSUmotor1}×V_{PSUmotor1})+(I_{PSUmotor2}×V_{PSUmotor2}) and comparing this result to Power_{ref};
setting a first speed reference (ω_{ref1}) that is desired at the first downhole motor and a second speed reference (ω_{ref2}) that is desired at a second downhole motor based on the comparison;
driving the first motor at ω_{ref1} and the second motor at ω_{ref2} based on rotational data for each motor; and
continuously adjusting ω_{ref1} and ω_{ref2}, as necessary to keep the result of (I_{PSUmotor1}×V_{PSUmotor1})+(I_{PSUmotor2}×V_{PSUmotor2}) equal to Power_{ref}.

16. The method of claim 15 further comprising:
measuring a rotations count (N₁) of the first downhole motor;
measuring a rotations count (N₂) of the second downhole motor; and
further adjusting ω_{ref1} and ω_{ref2} until N₁ is equal to N₂.

17. The method of claim 16 further comprising:
determining P₁=(I_{PSUmotor1}×V_{PSUmotor1});
determining P₂=(I_{PSUmotor2}×V_{PSUmotor2}); and
further adjusting ω_{ref1} and ω_{ref2} until P₁ is equal to P₂.

18. The method of claim 17 further comprising:
accepting a first gain to determine how much influence N₁ is equal to N₂ has over the adjusting for ω_{ref1} and ω_{ref2}; and
a second gain to determine how much influence P₁ is equal to P₂ has over the adjusting for ω_{ref1} and ω_{ref2}.

19. The control system of claim 1 wherein:
the motor, measurement device, motor rotational feedback sensor, and the motor controller are each positioned within a downhole tool.

20. The method of claim 15 wherein:
the first downhole motor and the second downhole motor are contained within a downhole tool that operates within an open hole section of a wellbore.
